(19) United States
(12) Patent Application Publication
(10) Pub. No.: US 2002/0067688 A1
(43) Pub. Date: Jun. 6, 2002

(54) OPTICAL DISC AND MOLD FOR MANUFACTURING THE OPTICAL DISC

(76) Inventors: TETSUYA IIDA, SAITAMA-KEN (JP); KEIJI SUGA, SAITAMA-KEN (JP); TETSUYA IMAI, SAITAMA-KEN (JP); YOSHITSUGU ARAKI, SAITAMA-KEN (JP)

Correspondence Address: Arent Fox Kintner Plotkin & Kahn PLLC, 1050 Connecticut Avenue N W Suite 600, Washington, DC, 20036-5339, US

(21) Appl. No.: 09/145,416

(22) Filed: Sep. 1, 1998

(30) Foreign Application Priority Data
Sep. 2, 1997 (JP) 9-252859

(51) Int. Cl. G11B 7/24

(52) U.S. Cl. 369/275.3; 369/275.4

(57) ABSTRACT

A substrate of an optical disc is formed by injection molding. One of the surfaces of the substrate has a plurality of pits corresponding to information signals. The other surface has a plurality of dummy pits.

### BACKGROUND OF THE INVENTION

The present invention relates to an optical disc such as the digital versatile disc (DVD), to a mold used in an injection molding machine for manufacturing the optical disc, and to an injection molding machine for manufacturing the optical disc.

FIG. 6 is a sectional view of a part of a conventional compact disc (hereinafter called CD). The CD has a substrate 30 having a thickness of about 1.2 mm, made of transparent polycarbonate. On one of surfaces of the substrate, an information recording surface 31 is formed. The recording surface 31 comprises pits which are spirally formed. The other surface is finished to a mirror surface to form an information reading surface 30a.

A reflection layer 32 is formed on the recording surface 31 by vacuum deposition of aluminum. On the reflection layer 32, a protection layer 33 consisting of resin is formed. Formed on the protection layer 33 is a coating 34 of print for a label.

The information recorded on the recording surface 31 is read by a laxer beam 35 applied from the reading surface 30a and reflected from the reflection layer 32.

FIG. 7 is a sectional view showing an injection molding machine for molding the substrate 30 of the CD. The injection molding machine comprises a fixed mold 101, a movable mold 102, a stamper block 103 provided on the fixed mold 101, a stamper block 104 on the movable mold 102, and a cavity 105 formed between the stamper blocks 103 and 104.

A stamper 106 is provided on the stamper block 103 of the fixed mold 101 so as to be located in the cavity 105 and secured thereto by an outer ring 107 and an inside holder 108. The surface of the stamper block 104, facing the cavity 105, is formed into a mirror surface.

In the central portion of the fixed mold 101, a sprue bush 109 having a resin pouring passage 109a is provided. In the central portion of the movable mold 102, a cutting pin 110 is axially slidably mounted so as to cut a molded disc to form a central hole therein.

Resin is poured in the cavity 105 passing through the passage 109a and solidified so that pits on the stamper 106 are transferred to the resin.

However, the stamper 106 has pits corresponding to the information to be recorded on the substrate, and the stamper block 104 of the movable mold side has a mirror surface. Such a difference between the surfaces of the mold generates residual stresses in the resin from the following. The residual stress causes the substrate to warp.

1. Residual Stress Caused by Flow

In the charging and cooling process of the high polymer material such as polycarbonate, the flow speed of melt resin charged in the cavity 105 is high in a central portion with respect to the thickness of space of the cavity, and becomes progressively slower toward the stamper 106 and stamper block 104. As a result, such a speed difference causes the difference between shearing speeds.

Each of high polymer chains of resin near the stamper which are being solidified having slow speed receives a large shearing force of a subsequent resin, and is extended in the flowing direction. Consequently, the chain is solidified in the extended state. Namely, the resin is solidified without the tensile stress in the high polymer chain being relaxed, remaining the stress therein.

In addition, the flow speed of the resin at the stamper 106 having pits is different from the flow speed of the resin at the movable block 104 having a mirror surface. In other words, the distribution of the speed of the flowing resin is not symmetrical with respect to the center of the thickness of the cavity 105.

FIG. 8a shows a condition that a resin 111 flows in the cavity 105 in an unequal speed distribution. The high polymer chain near the stamper 106 having an embossed surface receives a large shearing stress and is largely extended and oriented as shown in FIG. 8a, which causes the difference between residual stresses at opposite sides of the cavity 105.

FIG. 8b shows a condition where the resin 111 in the cavity 105 is cooled and solidified and becomes a solid resin 112. As will be understood from FIG. 8b, the oriented high polymer chains in FIG. 8a are cooled after the stopping of the flow and before relaxation, and the resin is solidified without the residual stress in the high polymer chains being relaxed.

FIG. 8c shows a condition that the resin 112 is taken out from the mold, and the residual stress in the high polymer chains is relaxed, so that the high polymer chains shrink. Since the shrinkage at the information recording side (stamper 106 side) is large, the substrate is warped to the side.

2. Residual Stress Caused by Thermal Stress

As described above, the resin 112 shrinks with the change of temperature in the cooling process. However, the contact area of the resin on the stamper 106 having an embossed surface is larger than that on the stamper block 104 having a mirror surface. Namely, the temperature distribution of the resin in the cavity is not symmetrical with respect to the center in the width direction. Accordingly, ununiform shrinkage occurs in the substrate, resulting in the residual of thermal stress.

Therefore, in the disc substrate, the residual stress generates caused by the ununiform shrinkage.

These residual stresses causes the disc to be warped with time and/or generates partial double refraction. As a result, there arise the problems that the control for reading the pits can not be exactly carried out due to the warp of the disc and the double refraction, and hence the recorded information can not be accurately read.

### SUMMARY OF THE INVENTION

An object of the present invention is to provide an optical disc without warp.

Another object of the present invention is to provide a mold which may manufacture a substrate without generating asymmetric residual stress.

According to the present invention, there is provided an optical disc including a substrate formed by injection molding and having opposite surfaces wherein one of the surfaces has a plurality of pits corresponding to information signals, and the other surface has a plurality of dummy pits.

The present invention further provides an optical disc including a substrate formed by injection molding and having an information recording surface and an information reading surface formed on opposite sides thereof, wherein the information recording surface has a plurality of dummy pits, and the information reading surface has a plurality of dummy pits.

The dummy pits are formed so as not to generate residual stress in the substrate at the injection molding.

The present invention further provides a mold for molding a substrate of an optical disc by an injection molding machine having a fixed mold and a movable mold for forming a cavity there-between, comprising, a first stamper having pits corresponding to information to be recorded on the optical disc and secured to one of the molds, and a second stamper having dummy pits for forming dummy pits on a surface of the substrate and secured to the other mold.

These and other objects and features of the present invention will become more apparent from the following detailed description with reference to the accompanying drawings.

### BRIEF DESCRIPTION OF DRAWINGS

FIG. 1 is a sectional view showing a part of an optical disc according to the present invention;

FIG. 2 is a sectional view showing an injection molding machine for molding a substrate of the optical disc;

FIG. 3 is an enlarged sectional view of a central portion of the injection molding machine of FIG. 1;

FIGS. 4a to 4c are sectional views showing conditions of resin;

FIG. 5a is a table showing measured values of jitter which are generated at four points when bits of a conventional optical disc is read;

FIG. 5b is a table showing measured values of jitter which are generated at four points when bits of the optical disc according to the present invention is read;

FIG. 6 is a sectional view of a part of a conventional CD;

FIG. 7 is a sectional view showing an injection molding machine for molding a substrate of the CD; and

FIGS. 8a to 8c are sectional views showing conditions of resin.

### DETAILED DESCRIPTION OF THE PREFERRED EMBODIMENT

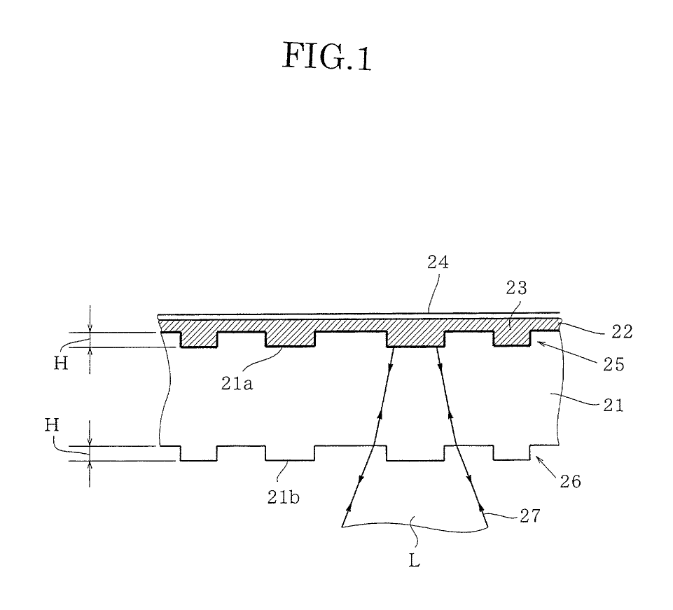

FIG. 1 is a sectional view showing a part of an optical disc according to the present invention. The disc has a substrate 21 having a thickness of about 1.2 mm and made of transparent polycarbonate. On one of the surfaces of the substrate 21, an information recording surface 25 having a plurality of spirally arranged information pits 21a is formed. On the other surface of the substrate 21, an information reading embossed surface 26 is formed.

The information reading surface 26 has a plurality of dummy pits 21b each having the same depth H as the depth H of the information pit 21a. The pit 21b does not carry information, and hence is physically formed.

A reflection layer 22 is formed on the recording surface 25 by vacuum deposition of aluminum, so that the information by the pits 21a is transferred to the reflection layer. On the reflection layer 25, a protection layer 23 consisting of resin is formed. Formed on the protection layer 23 is a coating 24 of print for a label.

The information recorded on the recording surface 25 is read by a laser beam 27 applied from the reading surface 26 and reflected from the reflection layer 22.

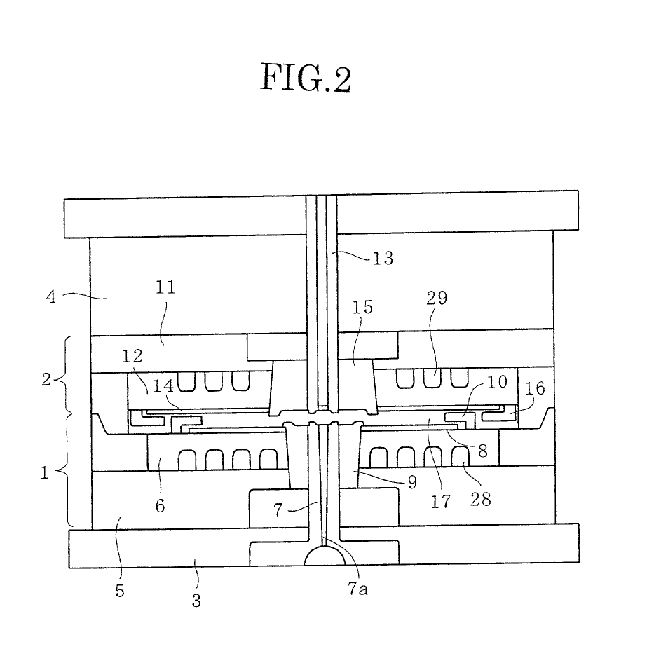

FIG. 2 is a sectional view showing an injection molding machine for molding the substrate 21 of the CD. The injection molding machine comprises a fixed mold 1 securely mounted on a fixed die plate 3, and a movable mold 2 secured to a fixed die plate 4. The fixed mold 1 has a base plate 5 and a stamper block 6 provided on the base plate 5 to form a coolant groove 28. The movable mold 2 comprises a base plate 11 and a stamper block 12 on the movable mold 2 to form a coolant groove 29. A cavity 17 is formed between the stamper blocks 6 and 12.

A first stamper 8 is provided on the stamper block 6 of the fixed mold 1 so as to be located in the cavity 17 and secured thereto by an outer ring 10 and an inside holder 9. On the surface of the stamper block 12, a second stamper 14 is mounted and secured thereto by an inside holder 15 and an outer ring 16.

In the central portion of the fixed mold 1, a sprue bush 7 having a resin pouring passage 7a is provided. In the central portion of the movable mold 2, a cutting pin 13 is axially slidably mounted so as to cut a molded disc to form a central hole therein.

On one of the first and second stampers 8 and 14, for example, on the first stamper 8, pits corresponding to information are formed, and on the second stamper 14, pits for dummy pits are formed. Thus, a substrate having information carrying pits and dummy pits on opposite surfaces is molded, such as the substrate 21 of FIG. 1.

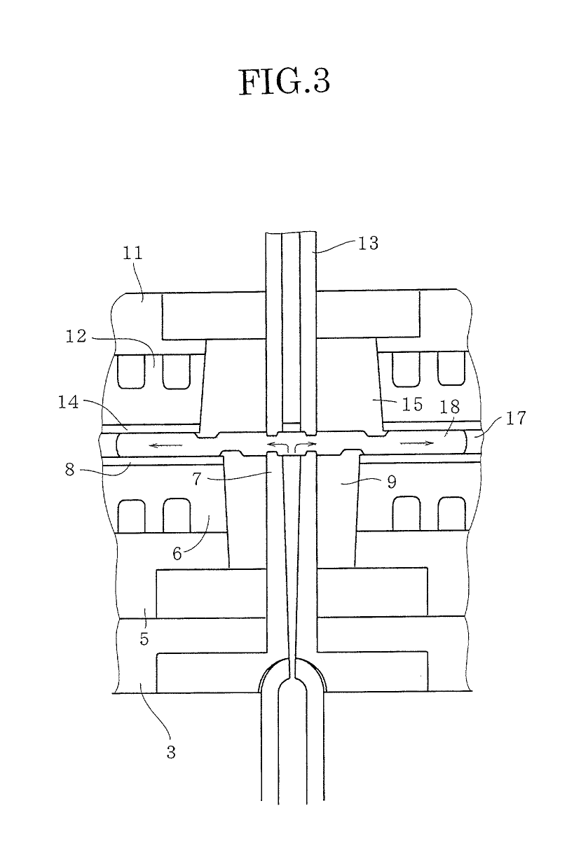

FIG. 3 is an enlarged sectional view of a central portion of the injection molding machine of FIG. 1. A resin 18 is poured in the cavity 17 passing through the passage 7a of the sprue bush 7 and flows toward the peripheral position of the cavity.

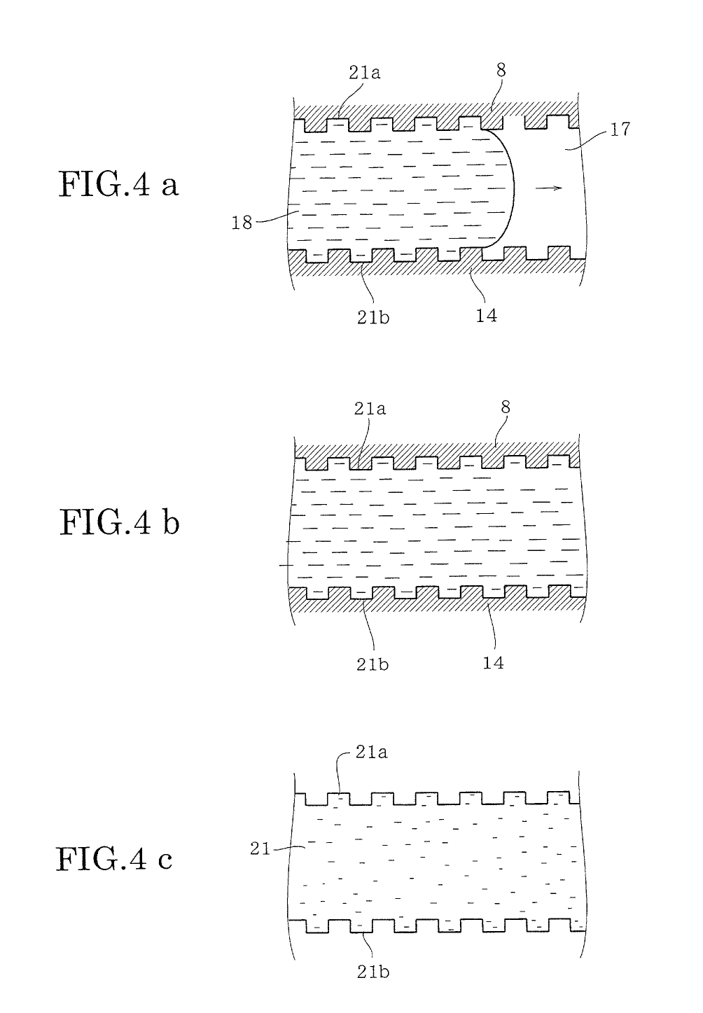

FIG. 4a shows a condition where the resin 18 flows in the cavity 17. The first stamper 8 has an embossed surface corresponding to the information pits 21a, and the second stamper 14 has an embossed surface corresponding to the dummy pits 21b. Since both the embossed surfaces of the opposite sides of the cavity has pits each having approximately equal depth, the resin 18 on one of the opposite sides flows at approximately the same speed as that of the other side.

Therefore, in a substrate having a thickness of 0.6 mm grade used for the DVD, the distribution of the shearing speed is approximately symmetrical about the center with respect the thickness direction of the disc. As shown in FIG. 4b, in the solidified resin 19, residual stresses in high polymer are symmetrically distributed about the center with respect to the direction of the thickness.

Therefore, the substrate 21 removed from the mold is not warped with the time, even if the residual stresses are relaxed as shown in FIG. 4c. Thus, the optical disc manufactured with the substrate 21 is not warped.

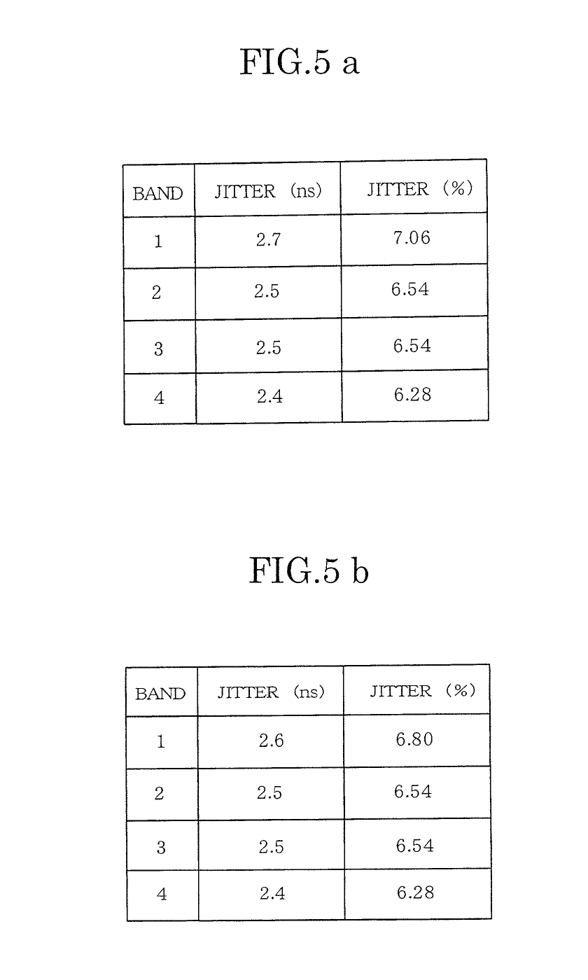

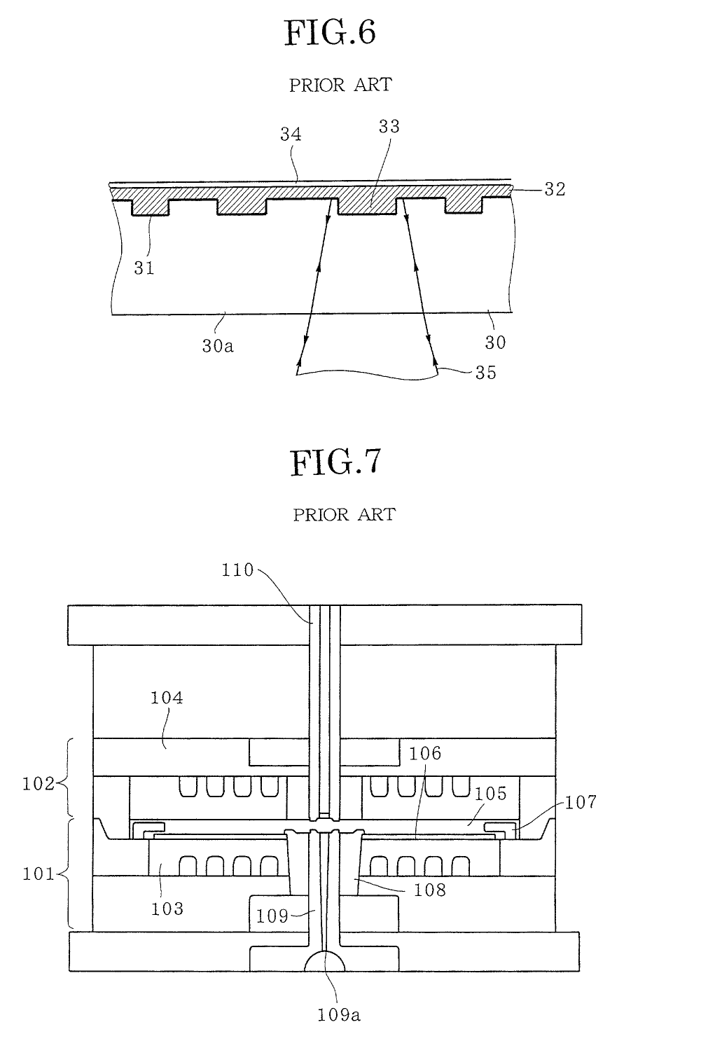

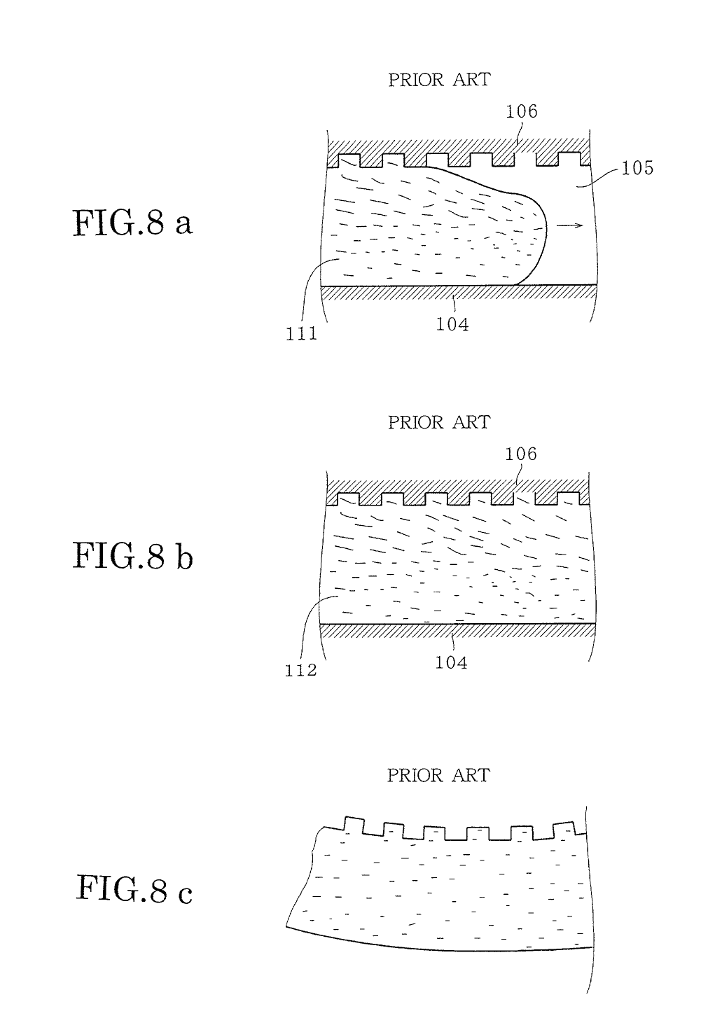

FIG. 5a is a table showing measured values of jitter which are generated at four points when bits of a conventional optical disc is read, scanning at a predetermined constant line speed, and FIG. 5b is a table showing that of a disc according to the present invention, which are obtained at the same line speed as the conventional disc.

The values in the graphs are represented by the changing value (ns) and its changing ratio (%) with respect to the length of a pit which corresponds to a length corresponding to three times as large as the cycle T of the synchronous clock signal.

As understood from the tables, information on the disc of the present invention can be read at almost the same accuracy as the conventional disc. This means that the dummy pits 21b on the information reading surface 26 do not affect the reading of the information.

The dummy pits 21b may be formed into the same shape as the information pits, and the dummy pits are oriented in the same direction as the information pits or the inverse direction.

The width of the dummy pit may be equal to the width of the information pit.

In short, the shape and the disposition of the dummy pit may be properly selected unless residual stress is not generated in the substrate.

In accordance with the present invention, it is possible to provide an optical disc which is not warped.

While the invention has been described in conjunction with preferred specific embodiment thereof, it will be understood that this description is intended to illustrate and not limit the scope of the invention, which is defined by the following claims.

What is claimed is

1. An optical disc including a substrate formed by injection molding and having opposite surfaces wherein one of the surfaces has a plurality of pits corresponding to information signals, and the other surface has a plurality of dummy pits.

2. An optical disc including a substrate formed by injection molding and having an information recording surface and an information reading surface formed on opposite sides thereof, wherein the information recording surface has a plurality of pits, and the information reading surface has a plurality of dummy pits.

3. The optical disc according to claim 1 wherein the dummy pits are formed so as not to generate residual stresses in the substrate at the injection molding.

4. The optical disc according to claim 2 wherein the dummy pits are formed so as not to generate residual stresses in the substrate at the injection molding.

5. A mold for molding a substrate of an optical disc by an injection molding machine having a fixed mold and a movable mold for forming a cavity there-between, comprising:
a first stamper having pits corresponding to information to be recorded on the optical disc and secured to one of the molds; and
a second stamper having dummy pits for forming dummy pits on a surface of the substrate and secured to the other mold.

6. An injection molding machine for molding a substrate of an optical disc having a fixed mold and a movable mold for forming a cavity there-between comprising:
a first stamper having pits corresponding to information to be recorded on the optical disc and secured to one of the molds; and
a second stamper having pits on a surface of the substrate and secured to the other mold.
